(19) United States
(12) Patent Application Publication
(10) Pub. No.: US 2017/0057763 A1
(43) Pub. Date: Mar. 2, 2017

(54) Articulated Barge Loader

(71) Applicant: Frank Kelly, New Orleans, LA (US)

(72) Inventor: Frank Kelly, New Orleans, LA (US)

(21) Appl. No.: 14/842,478

(22) Filed: Sep. 1, 2015

(51) Int. Cl. B65G 67/60; B66C 3/02; B63B 27/28; B63B 25/04; B63B 27/12

(52) U.S. Cl. CPC B65G 67/606; B63B 25/04; B63B 27/12; B63B 27/28; B66C 3/02

(57) ABSTRACT

An apparatus, system, and method of loading of a compartmented dry-bulk-cargo barge in an efficient, safe, load-balanced, and environmentally responsible way, minimizing exposure to the elements, spillage, and spread of dust particles from the dry-bulk materials, through existing small hatch openings in barge compartment covers, without removing barge compartment covers, using an articulated arrangement of connected conveyers with rotating and telescoping capabilities, providing rapid change of position and precise positioning with minimal movement of the compartmented dry-hulk-cargo barge.

This invention provides an apparatus for loading dry bulk material into a barge via a set of conveyor belts operatively connected to a rotating boom and telescoping spout, which has the ability to quickly and efficiently deposit dry bulk material into relatively small hatch openings on a barge. The articulated barge loader further provides for loading material into floating barges in a level manner, while minimizing the dry bulk material's exposure to the elements, and also reducing the spread of dust particles generating by the loading of such dry bulk material. This invention relates to the balance between loading a barge with minimal movement of said barge, while at the same time reducing the exposure of the dry bulk material to the elements.

This invention is a solution to a problem encountered in the field of transportation of dry bulk material. Transportation of this dry bulk material, such as grain, coal, or sugars, is commonly facilitated by the use of a transportation vessel known as a barge. Such barges typically contain openings known as hatches, whereby the dry bulk cargo may be loaded into the barge for transport. Due to the weather-sensitivity of certain types of dry bulk cargo, these hatches may require fabricated covers to protect the dry bulk cargo from the elements during loading and transport. It may be appreciated by those in the art that the uncovering and recovering such covers on the openings of the main hatches of a barge is a time-consuming process that significantly adds to the time required to load the barge with the dry bulk material.

The present invention is designed to facilitate loading of the dry bulk material onto the barge via the small hatch openings on the barge, thereby eliminating the need to uncover the main hatches on the barge. In the present invention, the dry bulk material is able to be deposited into these small hatch openings, rather than taking the time to open and maneuver between the main hatches on the barge, via a set of conveyors and a telescoping spout that can be strategically placed into the small hatch openings on the barge.

In contrast to the present invention, the conventional method of loading dry bulk material into a barge requires lifting the covers on the main hatches of the barge, rather than utilizing the small hatch openings. A sample depiction of the conventional loading of such a barge may be seen in FIGS. 3 and 4, which depict use of an imprecise instrument, such as a clamshell, picking up dry bulk material from one source and unloading the dry bulk material into large hatch openings. It may be appreciated by those in the art that such a method requires lifting of covers on the main hatches, which is a time-consuming, labor-intensive, and arduous process. Further, loading by use of the main hatches may require movement of the barge itself to place it in line with a stationary loader. Such movement of the barge vessel requires a great deal of time in the loading process. Use of these conventional loading methods thus increases the overall loading time of the barge significantly. It is therefore an object of the present invention to increase the efficiency of the barge loading process by reducing the time required to load the dry bulk material into the barge.

A second problem encountered in the field of barge loading is maintaining the stability of the barge as it is being loaded. For example, if a significant amount of dry bulk material is loaded via one main hatch at one end of the barge, it may capsize or otherwise get damaged. It is therefore a further object of the present invention to load the dry bulk material into the barge in an even fashion, such that the stability of the barge is maintained throughout the loading process.

A further problem encountered in the pertinent art is preserving the relative purity of both the dry bulk material and the surrounding environment, for health purposes, as large amounts of dry bulk material are loaded into the product loading barge. In regards to the dry bulk material, many types of dry bulk material must be protected from the elements as it is loaded into the barge for subsequent transport. Regarding the surrounding environment, the loading of such dry bulk material often creates large amounts of dust plumes as the dry bulk material is deposited in the product loading barge. It may be appreciated that in controlling the amount of dry bulk material being loaded into the barge, such dust plumes may in turn be minimized for environmental concerns. It is therefore an object of the present invention to provide for a manner of depositing the dry bulk material in a way that minimizes the dust plume created by such deposit, thereby providing a more environmentally-friendly method of loading a product barge.

None of the several existing systems or methods of loading a hopper barge address the specific need to decrease loading time of the barge via utilizing the small hatch openings on the barge, or the need for maintaining the stability of the barge vessel while also efficiently loading the barge with the dry bulk material.

U.S. Pat. No. 4,525,107, issued to Feldsted in 1985 on a “Barge having a pneumatic loading an unloading system,” discloses the conventional pneumatic barge, and covers a barge, including a system for pneumatic unloading of cement or other dry, bulk, powdered material from the barge into a receptacle. The barge includes a barge hull; a plurality of side-by-side hoppers disposed in the hull to receive and store the material; a collector system for each hopper to unload the material from the hopper and convey the material to a vacuum-pressure pneumatic conveyor; and a discharge conduit connected to the discharge outlet of the pneumatic conveyor for conveying the material from the conveyor to the receptacle during the discharge cycle. The collector system has an air-assisted gravity conveyor disposed within each hopper to gather the material in each hopper to a plurality of predetermined longitudinally spaced points within each hopper; a suction nozzle communicating with each hopper at each point to unload the material from the hopper by vacuum suction; and a transporter assembly connected to each nozzle outside the hopper to transport the material within the hull from the nozzle to the pneumatic conveyor. The pneumatic conveyor has a storage vessel and a discharge outlet. The pneumatic conveyor is disposed centrally in the hull between hoppers, is connected with the transporter assembly, and alternatively fills its storage vessel with the material during a loading cycle and discharges the material from the storage vessel through the discharge outlet during a discharge cycle. The barge of the '107 Patent further includes a source of compressed air and a vacuum source in the hull.

Similarly, U.S. Pat. No. 3,420,388, issued to Briggs in 1969, discloses a “Barge handling and unloading system and method of handling and unloading barges,” wherein a shuttle barge is utilized to move cargo barges in a fore-and-aft direction past an unloading station. In the Briggs handling system, a mechanical barge unloader is located at the unloading station and cargo is removed from the cargo barges by the barge unloader during the course of the fore-and-aft movements and transferred to shore.

Recently, Publication No. WO 2012/032,134 A1 to Cartwright et al, published Mar. 15, 2012, disclosed a pneumatic bulk material conveying device for loading and/or unloading a ship. The pneumatic bulk material conveying device of the Cartwright publication has at least one conveying pipe with two rigid pipe end portions and a pipe central portion connecting the latter. The two pipe end portions can be moved in a transitional manner relative to one another. Each of the pipe end portions is connected by the pipe central portion about pipe joint connections, which allow a pivoting of the respective pipe end portion relative to the pipe central portion about at least two joint axes. A ship-side connection mechanism is used to couple the ship-side ball-and-socket joint to the ship. The result is a conveying device with which an operationally reliable and low-wear and gentle conveying of the bulk material is possible.

It may be appreciated from the foregoing that there remains a need in the art for fast, efficient loading of dry bulk material into a barge, and more specifically for a barge loading apparatus that has the ability to reduce the time taken to load the barge by effectively utilizing the small hatches on the barge, and loading the dry bulk material through said hatches while maintaining the overall balance of the barge.

### SUMMARY OF THE INVENTION

The present invention provides an apparatus, system, and method of loading of a compartmented dry-bulk-cargo barge in an efficient, safe, load-balanced, and environmentally responsible way, minimizing exposure to the elements, spillage, and spread of dust particles from the dry-bulk materials, through existing small hatch openings in barge compartment covers, without removing barge compartment covers, using an articulated arrangement of connected conveyers with rotating and telescoping capabilities, providing rapid change of position and precise positioning with minimal movement of the compartmented dry-bulk-cargo barge.

The present invention solves existing problems encountered in the barge loading industry, including the problem of more quickly and efficiently loading a barge with dry bulk cargo while maintaining the overall stability of the barge vessel.

### BRIEF DESCRIPTION OF DRAWINGS

Reference will now be made to the drawings, wherein like parts are designated by like numerals, and wherein:

FIG. 1 is a top overview of an embodiment of the present invention;

FIG. 2 is a top view of a conventional, prior art system of loading a barge;

FIG. 3 is a depiction of a conventional, prior art system of loading a barge;

FIG. 4 is a depiction of a convention, prior art system of loading a barge;

FIG. 5 is a side view of an embodiment of the present invention;

FIG. 6 is the side view of FIG. 7, in a separate step of the process of an embodiment of the present invention;

FIG. 7 is an alternate side view of the barge, crane, hopper, transfer tower, and conveyor legs in an embodiment of the present invention;

FIG. 8 is an alternate side view of the barge, boom tower, transfer tower, conveyor legs, and spout in an embodiment of the present invention;

FIG. 9 is a detail of the transfer tower in an embodiment of the present invention;

FIG. 10 is a detail of a top view of the transfer tower in an embodiment of the present invention;

FIG. 11 is a detail of the boom tower in an embodiment of the present invention;

FIG. 12 is a detail of the spout arrangement in an embodiment of the present invention;

FIG. 13 is a detail of the telescoping spout in an embodiment of the present invention;

FIG. 14 is a detail of the clam shell bucket in an embodiment of the present invention;

FIG. 15 is a detail of the hopper in connection with the first leg conveyor belt in an embodiment of the present invention;

FIG. 16 is a detail of the first leg conveyor belt in connection with the loadbox and transfer tower in an embodiment of the present invention;

FIG. 17 is a detail of the second leg conveyor in connection with the boom tower in an embodiment of the present invention;

FIG. 18 is a detail of the control of an embodiment of the present invention; and

FIG. 19 is a detail of the spout depository in an embodiment of the present invention.

### DETAILED DESCRIPTION OF THE INVENTION

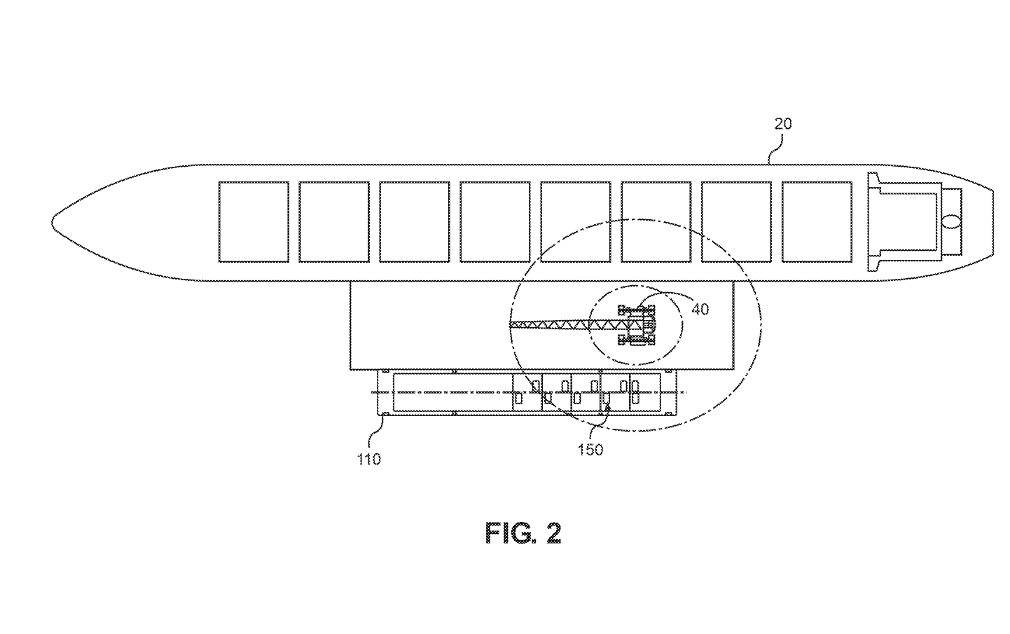

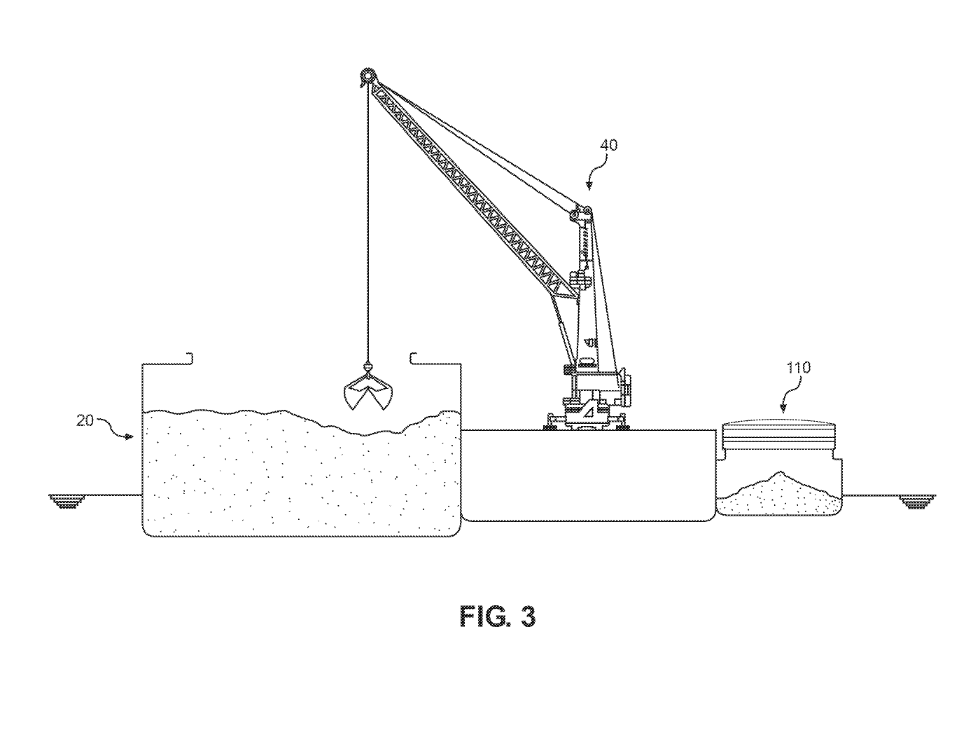

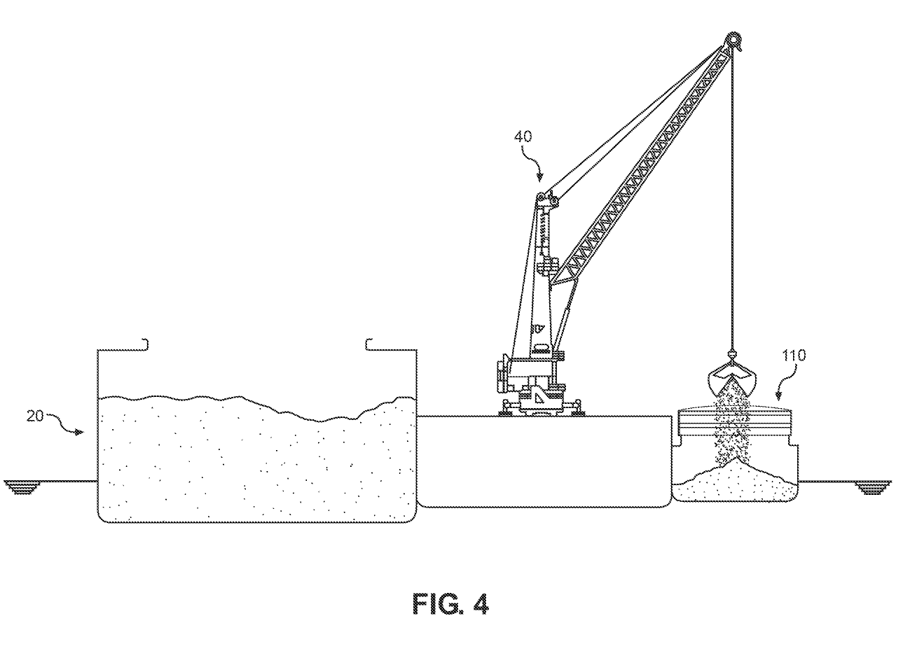

Turning now in reference to the drawings, FIGS. 2, 3, and 4 depict a conventional barge loading system, whereby a loading instrument 40, depicted in FIGS. 2-3 as a clamshell, may obtain a large amount of dry bulk material from ship 20 and in turn deposit it into product loading barge 110. It may be appreciated that in the conventional barge loading system of FIGS. 2, 3, and 4, small hatch openings 150 on loading product barge 110 may not be utilized, as the loading instrument 40 is not precise enough to deposit the dry bulk material into small hatch openings 150. Unloading of dry bulk material by loading instrument 40, as shown in FIG. 4, must thus be facilitated only by uncovering of large hatch openings of loading product barge 110.

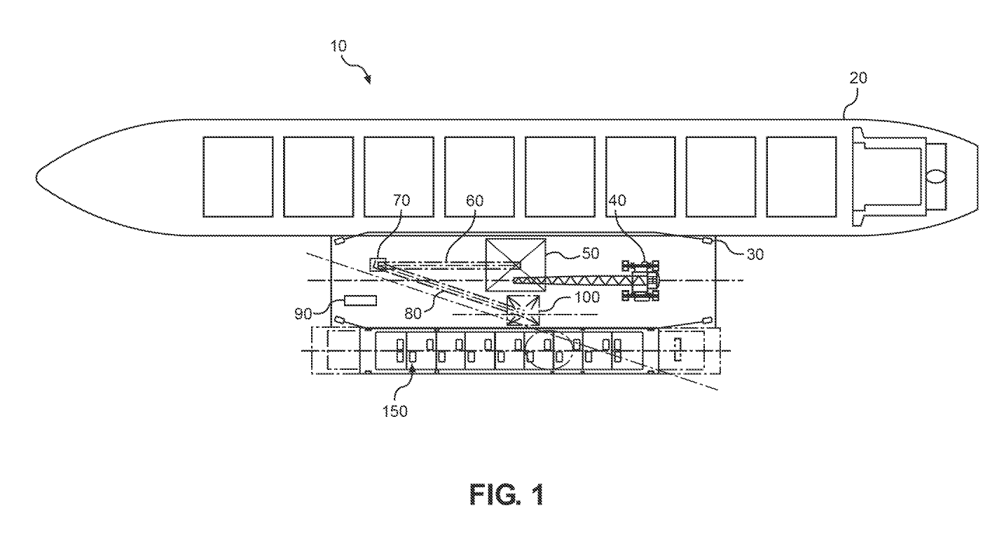

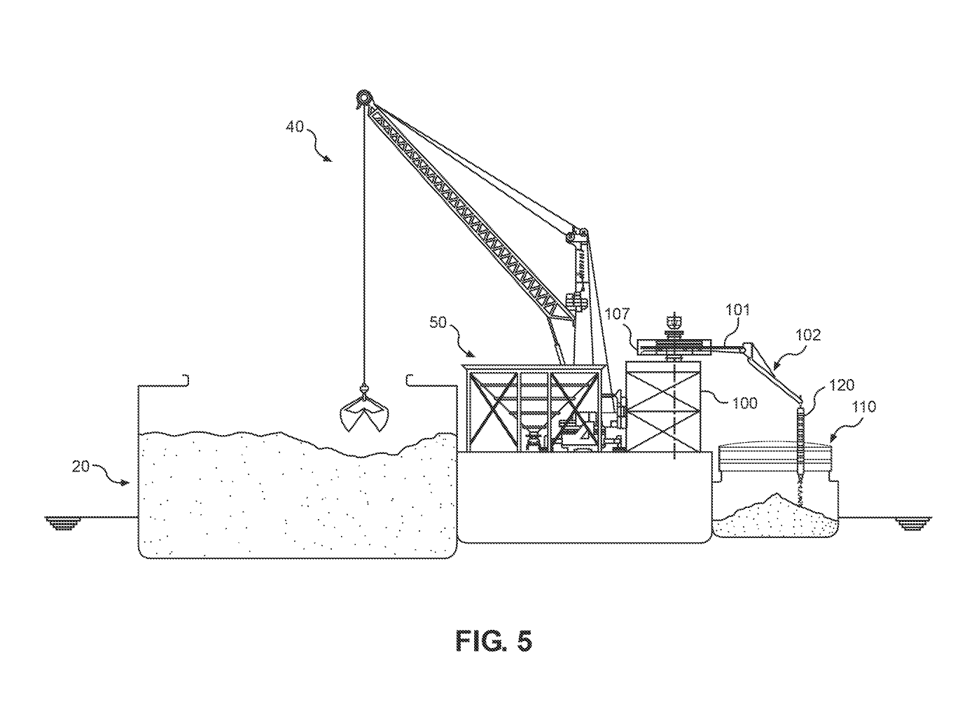

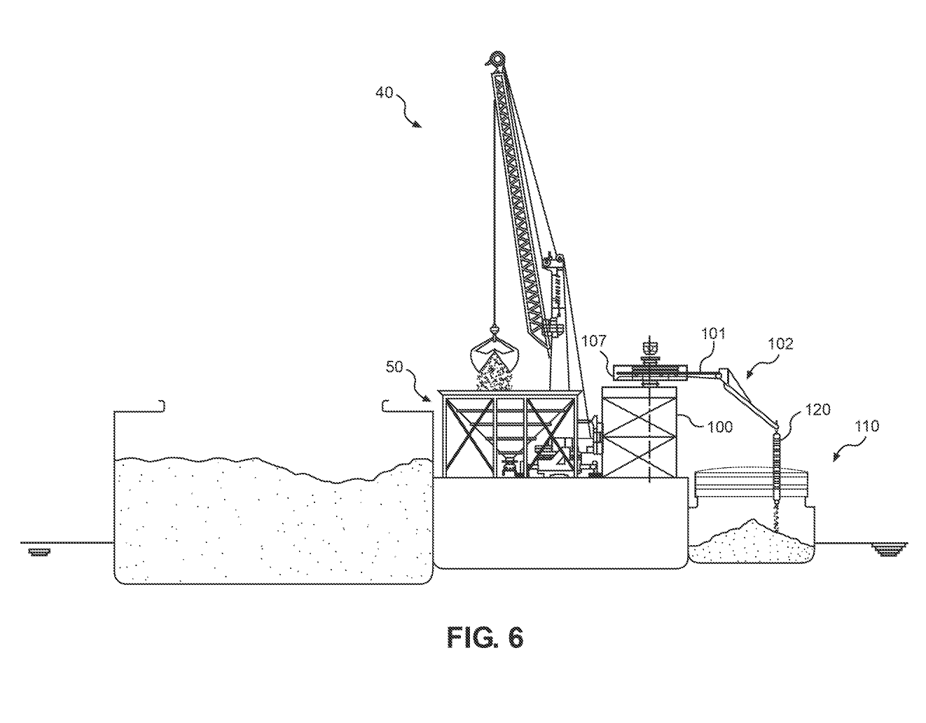

In contrast, FIG. 1 depicts an overview of the barge loading system 10 of the present invention. Loading barge 110 includes small hatch openings 150 for reception of dry bulk material. As shown in FIG. 1, barge loading system 10 includes a hopper 50 for initial reception of the dry bulk material from unloading ship 20; a first leg conveyor belt 60 for transfer of the dry bulk material to transfer tower 70; a second leg conveyor belt 80 for transfer of the dry bulk material to from transfer tower 70 to boom tower 100; and a telescoping spout 120 for transfer of the dry bulk material from boom tower 100 into small hatch openings 150 of loading product barge 10. As depicted in FIG. 1, multiple small hatch openings 150 may be utilized for reception of the dry bulk material due to the rotatable range of telescoping spout 120. In this manner, dry bulk material may be loaded efficiently into loading product barge 110 without requiring movement of the loading product barge 110 and without overbalancing loading product barge 110. Alternate side views of the overall barge loading system of the present invention are presented in FIGS. 5 and 6.

Turning now to FIG. 6, the dry bulk material to be deposited into the product loading barge [ ] is first poured into hopper 50. A conventional hopper may be forty feet wide and forty feet long, as shown in FIG. 1, holding a great amount of dry bulk material. The hopper 50 thus acts as a depository, as shown in FIG. 14, for a large amount of the material that will be loaded into the product loading barge 110 via small hatch openings 150. A depiction of the deposit of the dry bulk material into hopper may be seen in FIG. 6. As seen in FIG. 6, an instrument such as a clamshell 40 may acquire a large amount of dry bulk material from loading source 20 and be poured in bulk into hopper 50.

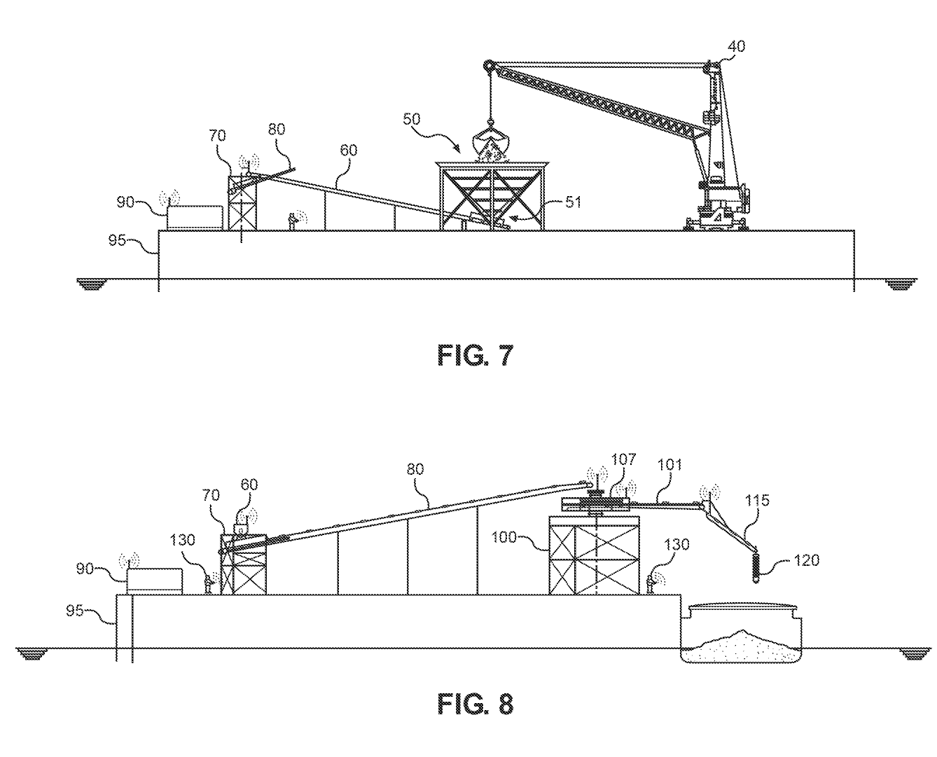

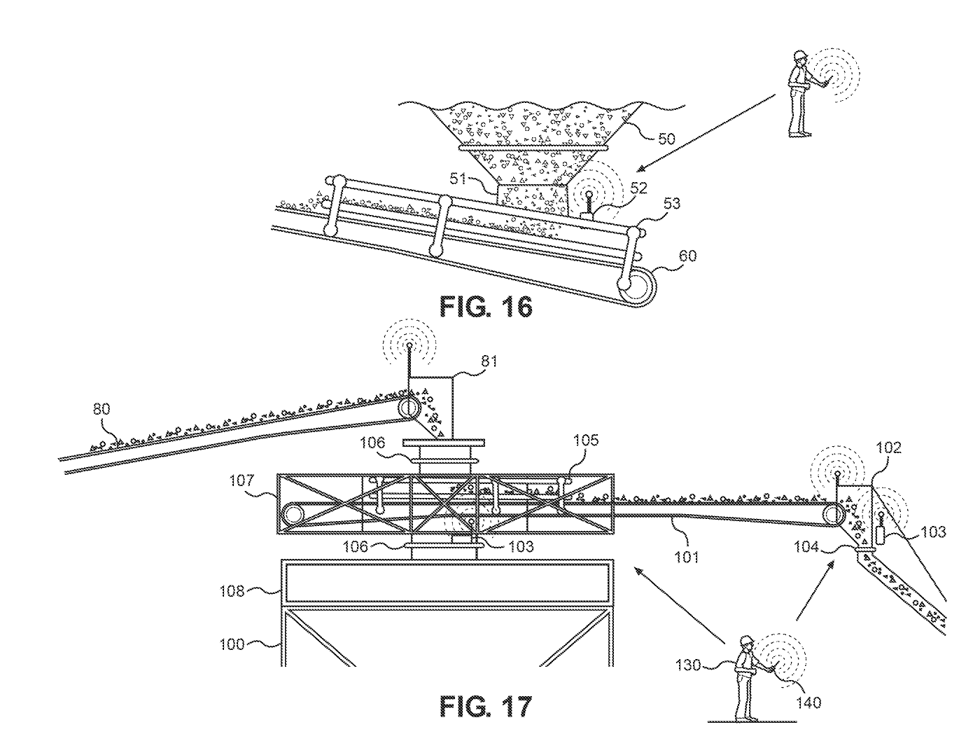

Turning now in reference to FIG. 7, the dry bulk material is then transferred from hopper 50 to transfer tower 70. As shown in FIG. 16, the dry bulk material flows through the hopper via a hopper discharge 51 into loadbox 53 for loading onto first leg conveyor belt 60 for subsequent transfer to transfer tower 70. Flow of the dry bulk material through the hopper discharge may be operated by remote control, as shown in FIG. 15. The dry bulk material is then transferred along first leg conveyor belt 60 to transfer tower 70 as facilitated by means known in the art.

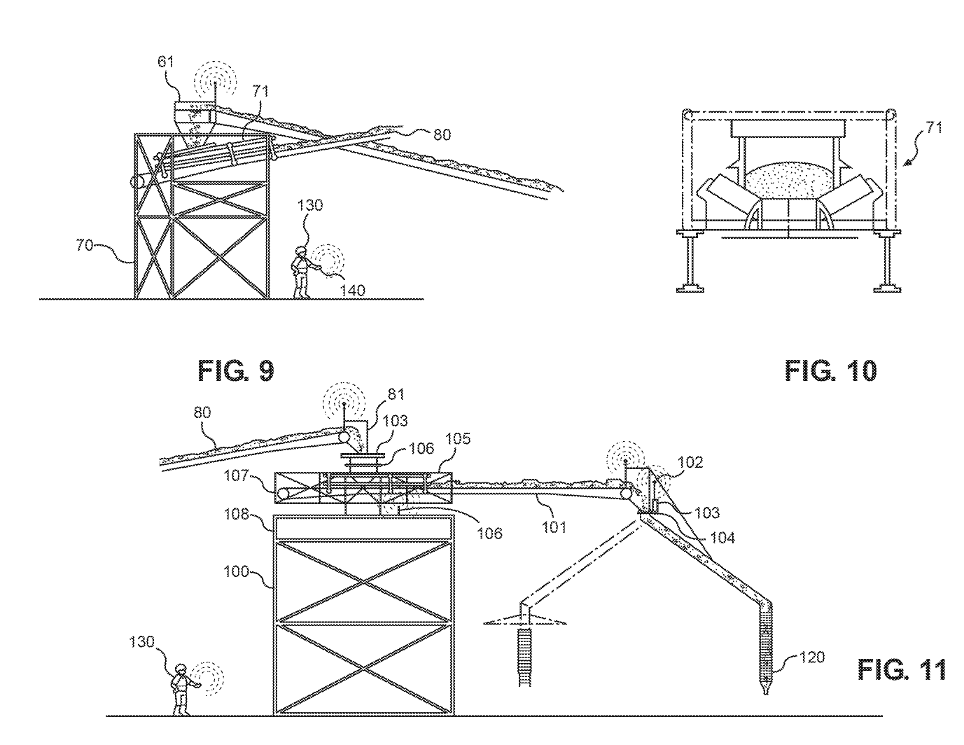

A detailed depiction of transfer tower 70 may be seen in FIG. 9. As pictured, dry bulk material is transported along first leg conveyor belt 60 and discharged in discharge section 61 of transfer tower 70. A detail of this discharge in transfer tower 70 may be seen in FIG. 16. The dry bulk material is then in turn placed onto second leg conveyor belt 80 for transport to boom tower 100, as depicted in FIGS. 8 and 17. Operation of the transfer tower 70 may be facilitated by remote control 140, as controlled by an employee 130 of the barge loading process. Dry bulk material may then be transferred from transfer tower 70 along second leg conveyor belt 80 to boom tower 100, which is facilitated by means known in the art.

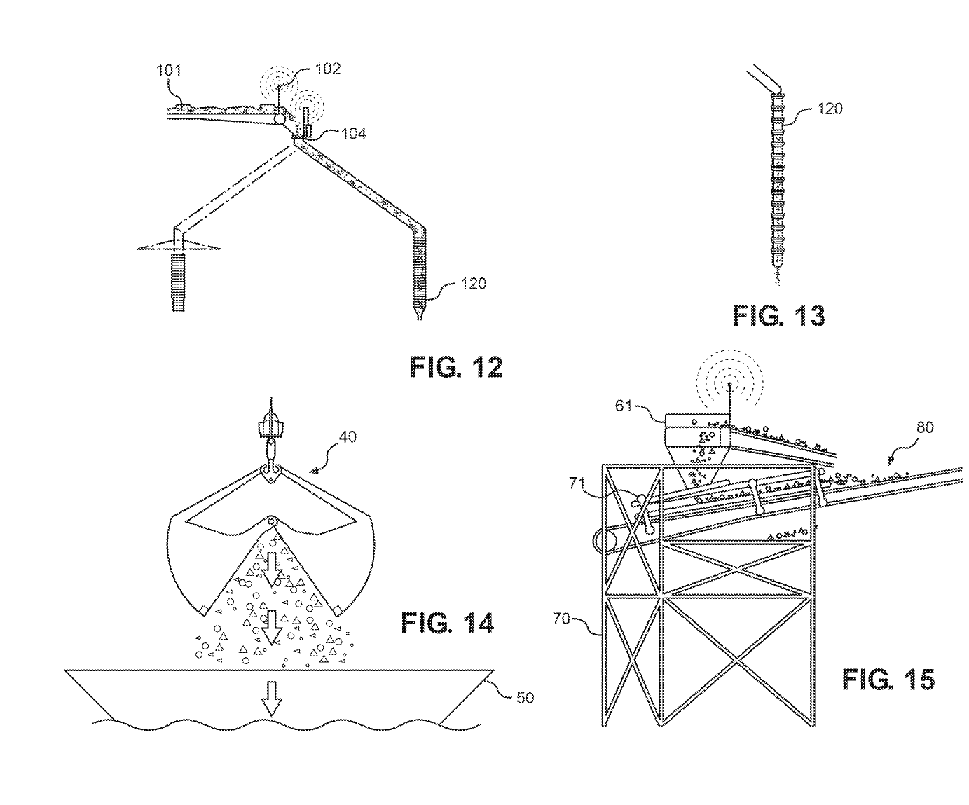

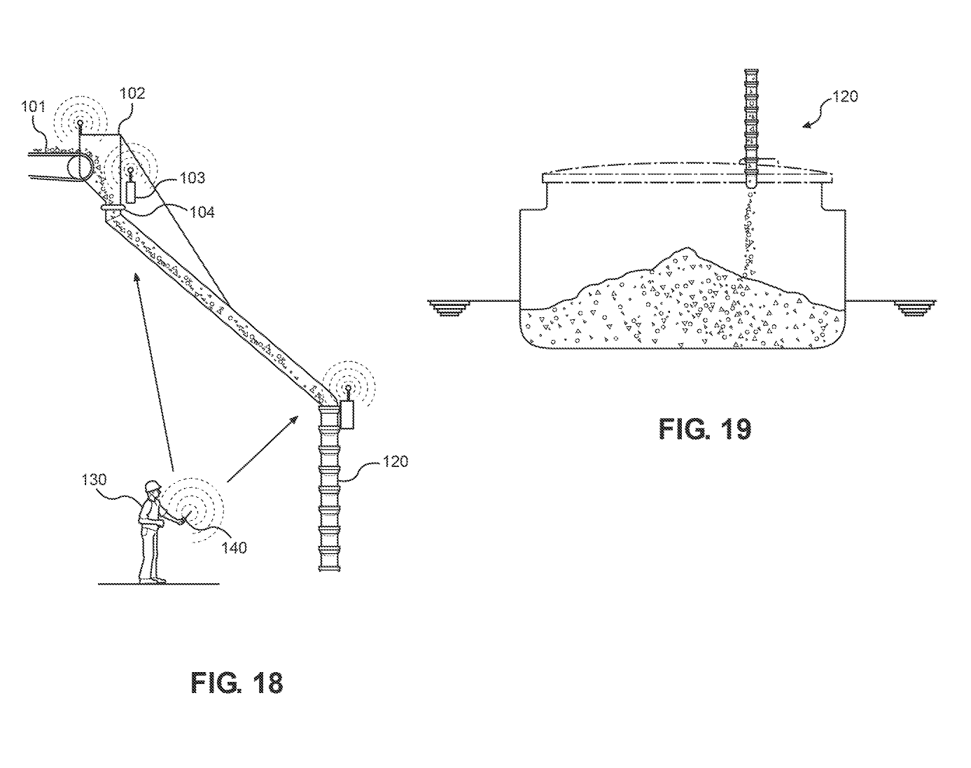

Turning now to FIG. 11, the dry bulk material is then deposited from second leg conveyor belt 80 into loadbox 105 of boom tower 100. As illustrated in FIG. 11, loadbox 105 may be rotatable. The dry bulk material is then passed onto boom conveyor 101, which is operatively connected to the rotatable loadbox 105 on boom tower 100. The dry bulk material is then transferred along the boom conveyor 101 by means known in the art through the boom conveyor discharge 102. This flow of dry bulk material through boom conveyor discharge 102 into telescoping spout 120 may be seen in further detail in FIGS. 12, 17, and 18. As shown in the above figures, facilitation of the transfer of dry bulk material through the boom tower 100 into telescoping spout 120 may be effected by remote control 140, as operated by an employee 130 of the barge loading process.

Telescoping spout 120 is also attached to rotatable bearing 104, which provides further maneuverability of the loading apparatus. Telescoping spout can therefore reach a number of small hatch openings 150 on the barge 110 when depositing the dry bulk material into the small hatch openings 150 on the barge 110. Such an operation of the telescoping spout 120 may be seen in FIGS. 5-6, 8, 11-13, and 19-20. As depicted in, for example, FIG. 19, the dry bulk material may be poured into small hatch openings 150 of barge 110. The relative precision and size of telescoping spout 120 may thus facilitate more efficient loading of barge 110 by utilizing small hatch openings 150.

As depicted in the foregoing illustrations, operation of the barge loading apparatus may be facilitated by a remote control, which may be wielded by relatively unskilled employees, thereby providing an additional advantage to the present invention. As depicted in FIGS. 7-9, 11-12, 15-16, and 18-19, the employee may remotely control the rotation and operation of hopper discharge 51, transfer tower 70, second leg conveyor belt discharge 81, loadbox 105, boom conveyor discharge 102, and rotation motion 103, among other operations.

It may be appreciated from the foregoing that the use of such a rotating bearing 104 connected to telescoping spout 120 facilitates the quick, efficient loading of product loading barge 110 by utilizing the small hatch openings 150 on product loading barge 110, thereby eliminating the time-consuming processes of uncovering the openings to the main hatches. Due to the range of operation of the telescoping spout, the product loading barge 110 may also be loaded evenly, facilitating stable loading of the product loading barge, without the need for moving product loading barge 110 after deposit of a certain amount of dry bulk material into product loading barge 110.

Many changes and modifications can be made in the present invention without departing form the spirit thereof. I therefor pray that my rights to the present invention be limited only by the scope of the appended claims.

1. An articulated barge loader apparatus for loading of a compartmented dry-bulk-cargo barge having multiple hatch covers each with at least one hatch opening, the apparatus comprising:
(i.) a hopper for initial deposit of dry-bulk material to be loaded into the barge;
(ii.) a first-leg conveyor to transfer the dry-bulk material from said hopper;
(iii.) a transfer tower to receive the dry-bulk material from said first-leg conveyor;
(iv.) a second-leg conveyor to transfer the dry-bulk material from said transfer tower;
(v.) a boom tower to receive the dry-bulk material from said second-leg conveyor;
(vi.) a boom conveyor to transfer the dry-bulk material from said boom tower; and
(vii.) a telescoping spout to discharge the dry-bulk material from said boom conveyor into the hatch openings of the barge;
where said boom conveyor is adapted to rotate about said boom tower on a rotatable bearing, and said telescoping spout is adapted to extend or contract as needed to be placed above any selected hatch opening.

2. The apparatus of claim 1, wherein said transfer tower further comprises a discharge apparatus and a loadbox for transferring said material to said second leg conveyor.

3. The apparatus of claim 1, wherein said boom tower further comprises a discharge apparatus and a loadbox for transferring said material to said boom conveyor.

4. The apparatus of claim 3, wherein said loadbox is rotatable.

5. The apparatus of claim 1, wherein said first leg conveyor, transfer tower, second leg conveyor, and boom tower are powered by remote control.

6. The apparatus of claim 1, wherein movement of said barge is minimized through use of said telescoping spout.

7-11. (canceled)
